(19) United States
(12) Patent Application Publication
(10) Pub. No.: US 2026/0301992 A1
(43) Pub. Date: Oct. 1, 2026

(54) A COMPOSITE PHOTOVOLTAIC CABLE

(71) Applicant: AMNACK LIMITED, Doncaster (GB)

(72) Inventor: Aaron WALSTOW, Doncaster (GB)

(73) Assignee: AMNACK LIMITED, Doncaster (GB)

(21) Appl. No.: 19/476,384

(22) PCT Filed: Apr. 12, 2024
(86) PCT No.: PCT/GB2024/050964

§ 371 Date: Oct. 17, 2025

(30) Foreign Application Priority Data
Apr. 19, 2023 (GB) 2305747.4

(51) Int. Cl. H01B 7/18; H01B 7/32; H01B 9/00; H01B 13/14; H02S 40/36

(52) U.S. Cl. CPC H01B 7/18; H01B 7/32; H01B 9/00; H01B 13/14; H02S 40/36

(57) ABSTRACT

A composite photovoltaic cable comprising at least two double insulated operating cores within an outer jacket or sheath.

### TECHNICAL FIELD OF THE INVENTION

The present invention relates generally to the field of electrical cables and more particularly to a composite cable for photovoltaic applications.

### BACKGROUND TO THE INVENTION

Double insulated cables are commonly used for the interconnection of photovoltaic systems such as solar panel arrays, there are challenges and difficulties faced with the current installation methods.

BS7671 (Wiring Regulations in the UK) clause 712.412.101 states that the electrical equipment up to the DC connection of the photovoltaic (PV) inverter shall be Class II or equivalent insulation. Currently this is achieved by installing double insulated, single core conductors.

Safety risks have been identified when installing these double insulated conductors, as they look visually similar to coaxial cables (that run to televisions etc.) but which carry no or negligible amounts of electricity, and they are also installed in similar areas such as in loft spaces and on the outside of buildings. Electricians are therefore required to affix labels to these double insulated conductors at regular intervals with warning messages to prevent them being cut which can cause injury or death to an unwary user.

Existing design solutions currently on the market do not satisfy the above requirements and the new design below solves all of the current issues.

### SUMMARY OF THE INVENTION

According to one aspect of the invention, there is provided a composite photovoltaic cable comprising at least two double insulated operating cores within an outer jacket or sheath.

The composite cable described above overcomes issues with the use of multiple single core cables (which are required for PV installations) by double encapsulating two or more single core cables, so that the two or more single core cables are still double insulated (in accordance with BS7671 clause 712.412.101), whilst the composite cable is now visually dissimilar to coaxial cable, and instead looking like a mains wiring cable.

Each of the operating cores will preferably be ozone resistant. Each of the operating cores will preferably be UV resistant. Each of the operating cores will preferably be water resistant. Each of the operating cores will preferably be low smoke. Each of the operating cores will preferably be zero halogen. Each of the operating cores will preferably have a voltage rating of 1000/1500V suitable for photovoltaic (PV) applications.

The composite cable may include at least two double insulated operating cores. In some cases, two double insulated operating cores will be used. In other cases, more than two, for example four double insulated operating cores can be used.

The at least two double insulated operating cores are preferably provided approximately centrally within the outer jacket or sheath. The at least two double insulated operating cores may abut each other or they may be separated. Where more than two double insulated operating cores are provided, abutment of the cores may define a void between them which may or may not be filled.

The composite cable may further comprise bedding within the outer jacket or sheath. The bedding may assist with defining the outer shape of the composite cable. The outer jacket or sheath can be provided directly about the outer side of the bedding. Alternatively, one or more armour layers may be provided about the outer side of the bedding and within the outer jacket or sheath.

The bedding within the composite cable may be or include a composition comprising polyvinylchloride with a K-value of between 35 and 80, di (2-propylheptyl) phthalate, at least one filler and a stabiliser.

In an embodiment, the at least one filler may comprise at least one polyvinylchloride filler.

The composition may be utilised as a bedding material for providing about the assembled cores of the composite cable, within the outer jacket or sheath or in circumstances where an outer jacket or sheath is not provided. However, given its properties, the composition may have other uses.

The composition has a high abrasion resistance that protects the composite cable from installation practices expected (such as difficult cable routes, and the cable being pulled along concrete floors and building work).

The composition has a high impact resistance that protects the composite cable from impacts, such as impacts from vehicle doors in tight parking situations.

The composition has good thermal stability to achieve operating temperatures of 90° C. that allow for higher current carrying capacities. For example, utilising the composition as a bedding material within a composite cable.

The composition has good UV stability which allows long term operation in sunlight for exterior use.

Standard grades of bedding material available as specified in the British Standards for such requirements, were trialled against the composition and, a composite cable including the composition used as bedding material had decreased stiffness compared to the same cable using standard bedding grades, which proved more difficult to install and route.

The K-value is a characteristic of the polyvinylchloride (PVC) resin which describes the length of the polymer molecules. It is usually a measure of the molecular weight of PVC based on measurements of viscosity of a PVC solution. It ranges usually between 35 and 80. In an embodiment, a K-value of approximately 70 has been found to be optimal.

Using PVC with a K-value of 70, the amount of the respective components may be as follows (on a weight basis):

| Material | Amount |
|---|---|
| PVC resin | 200-400, preferably approx. 300 |
| DPHP | 200-400, preferably approx. 250 |
| PVC Filler | 200-600, preferably approx. 400 |
| Stabiliser | 10-20, preferably approx. 15 |

In an embodiment, a particularly preferred formulation for the composite material is 319.1 parts of polyvinylchloride with a K-value of 70, 257 parts of di (2-propylheptyl) phthalate, 408.1 parts of PVC filler and 15.8 parts of stabiliser.

The bedding may be provided within the composite cable outside the at least two operating cores and within at least one outer jacket or sheath of the composite cable.

The bedding may be applied around the cores and/or at least partially between one or more of the operating cores. The bedding may act as a filler between the outer jacket or sheath and the operating cores. The bedding may act as a filler between the armour layer(s), for example steel wire armour, and the operating cores (depending on whether the cable is armoured or not).

There will preferably be at least a predetermined minimum thickness of bedding provided about all sides of the individual cores to ensure protection of the individual cores.

During installation, separation of the individual operating cores may be needed. In some installations approximately 2 metres is required of the operating cores to be ‘free from each other’. This is difficult to achieve when covering more than one operating core withing an outer sheathing, as the risk of damaging the internal cores is high when the outer sheathing is removed with cutting tools.

The composite cable may further comprise an elongate ripcord member or structure at least partially embedded within the composite cable and configured to open the outer jacket and any bedding.

The ripcord member or structure is preferably elongate, extending over the length of the composite cable.

The ripcord member or structure is preferably located immediately adjacent to one of the individual operating cores within the composite cable. In use, operating the ripcord member or structure which is located immediately adjacent to one of the individual operating cores means that at least one of the individual operating cores will be exposed without damaging the operating cores, allowing separation.

The ripcord member or structure may be made of any material and have any configuration.

In one form, the ripcord member or structure may be an engineered fibre rip cord. A fibre ripcord may be customized to meet specific application requirements, with various fibres and coatings. Plastic or metal ripcords could be used.

The ripcord may be flat, twisted or corded.

A high tensile strength ripcord is preferred given the size and nature of the larger composite cable formed with the at least two individual operating cores.

The ripcord is preferably located within the composite cable positioned next to the thinnest part of the inner covering (the smallest thickness of bedding material to the outer jacket or sheath).

The ripcord is preferably coextensive with at least one of the operating cores.

There is a requirement for an armoured version of the composite cable which then allows cable routes to be buried directly underground. The preferred position of the ripcord allows for use in armoured cable as well. In a preferred armoured embodiment, the armouring layer(s) are applied between the bedding and outer jacket or sheath, outside the rip cord. Once the outer jacket has been cut and the armouring has been separated, the ripcord can then be used as above to separate the bedding adjacent to the individual core. The

A warning message can be printed directly on the outside of the outer jacket or sheath of the cable for additional safety and to maintain a message such as ‘DANGER DC CABLE LIVE DURING DAYLIGHT’. As the printing is on the cable this removes the need for electricians to label the cable continuously along its route.

The composite cable of embodiments overcome these issues and will allow electrical installers to run a single cable that incorporates these double insulated conductors, within an outer sheathing, whilst having warning labels already applied, reducing the possibility of mistaking the cable for ‘non-power’, and still allowing a long length of the double insulated conductors to be freed from each other at the solar array.

To achieve the preferred positioning of the ripcord within the composite cable, a new tooling concept is also provided.

According to a second aspect of the invention, there is provided a tool for manufacturing a composite cable comprising at least two double insulated operating cores, the tool comprising an extrusion tip and an extrusion die located in series, the extrusion tip comprising an opening for each of the at least two double insulated operating cores and a secondary opening provided adjacent to one of the operating cores to position a ripcord member or structure coextensively beside the one of the operating cores.

In a preferred form, the extrusion die is located downstream of the extrusion tip, the extrusion die comprising a keying structure. The keying structure is preferably located on an internal side of the extrusion die.

The keying structure may have any shape and any configuration. As the purpose of the keying structure is to engage with a keyway, it is important that the shape and configuration of the keying structure correspond to that of the corresponding keyway.

In a preferred form, the extrusion tip includes at least one keyway in an external portion thereof to align the extrusion tip with an extrusion die. The at least one keyway may be provided relative to a front end of the extrusion tip. Preferably, the extrusion tip is aligned relative to an extrusion die via the at least one keyway and a corresponding at least one keying structure provided relative to the extrusion die.

The keying structure will preferably be received at least partially into a corresponding keyway on the extrusion tip to maintain the orientation of the extrusion tip relative to the extrusion die. This alignment of the extrusion tip relative to the extrusion die will preferably maintain the orientation of the individual cores and the ripcord as they exit the extrusion tip, relative to the extrusion die to ensure that the ripcord is positioned relative to the thinnest part of the bedding extruded about the individual cores and the ripcord by the extrusion die.

According to a third aspect of the invention there is provided a method of forming a composite cable comprising at least two double insulated operating cores, the method comprising the steps of feeding the at least two double insulated operating cores into an extrusion tip comprising an opening for each of the at least two double insulated operating cores and a secondary opening provided adjacent to one of the openings for a ripcord member or structure, and feeding the ripcord member or structure coextensively with the at least two double insulated operating cores through the extrusion tip to form an internal core and ripcord configuration.

The method may further comprise a step of feeding the internal core and ripcord configuration through an extrusion die with at least one bedding composition to form a bedded configuration.

The method may further comprise a step of sheathing the bedded configuration with at least one outer jacket or sheath to form a composite cable.

The method may be performed using a tool as provided in the second aspect and including the keying structure and at least one keyway discussed therein to ensure that the internal core and ripcord configuration exiting the extrusion tip is maintained aligned with the extrusion die so that the ripcord is positioned relative to the thinnest part of the bedding extruded about the individual cores and the ripcord by the extrusion die.

The conventional process that is used to twist cores together to form a multi-core cable is unsuitable for use with the composite cable as it was too difficult to remove the outer sheathing in the amount necessary (approximately 2 meters) without the risk of damaging the internal double insulated operating cores.

It was decided that the combination of a soft inner covering and a high tensile strength rip cord would allow for the rip cord to pull through the inner cable covering.

To achieve this the double insulated operating cores are preferably fed directly into the extrusion tip with the ripcord being held on the outer edge of one of the double insulated operating cores (to allow the rip cord to be positioned next to the thinnest part of the inner covering.

The running parameters of the manufacturing machine differ for each composite cable to account for different composite cable characteristics.

As mentioned above, the composite cable may be armoured or not. If the composite cable is armoured, a metal armour may be provided. A wire braid armour may be used however armour made from a plastic material such as an aramid braid may also be used.

Each operating core may be insulated. Any material may be used to insulate each operating core. A preferred material is XLPE although other materials may be used. Any insulation material would preferably have an operating temperature of 90° Celsius or higher.

As mentioned above, a dummy core may be provided in any composite cable.

The composite cable may be provided with an outer jacket or sleeve. Although a variety of materials may be used for the outer sleeve, the outer sleeve will normally be a material such as polyvinyl chloride. However, an armoured cable may be provided in which the outer sleeve is armour braid.

As mentioned above, the assembled cores may be taped for better security. Again, although a variety of materials may be used, a polyethylene tape may be provided about the assembled cores.

Chalk may be applied if the assembled cores are not taped.

One or more features of any one or more of aspects may be used in combination.

### DETAILED DESCRIPTION OF THE INVENTION

In order that the invention may be more clearly understood one or more embodiments thereof will now be described, by way of example only, with reference to the accompanying drawings, of which:

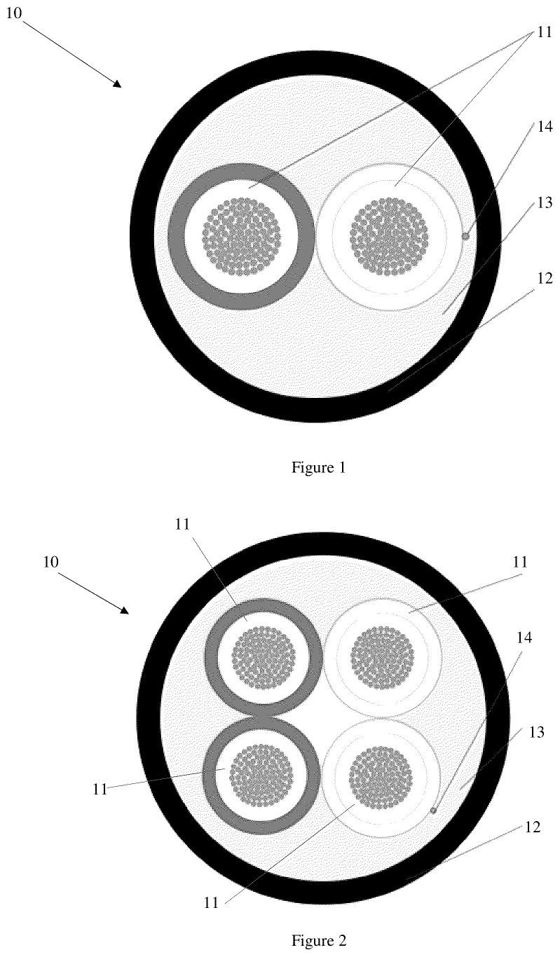

FIG. 1 is a schematic section view of a 2-core composite cable of an embodiment.

FIG. 2 is a schematic section view of a 4-core composite cable of an embodiment.

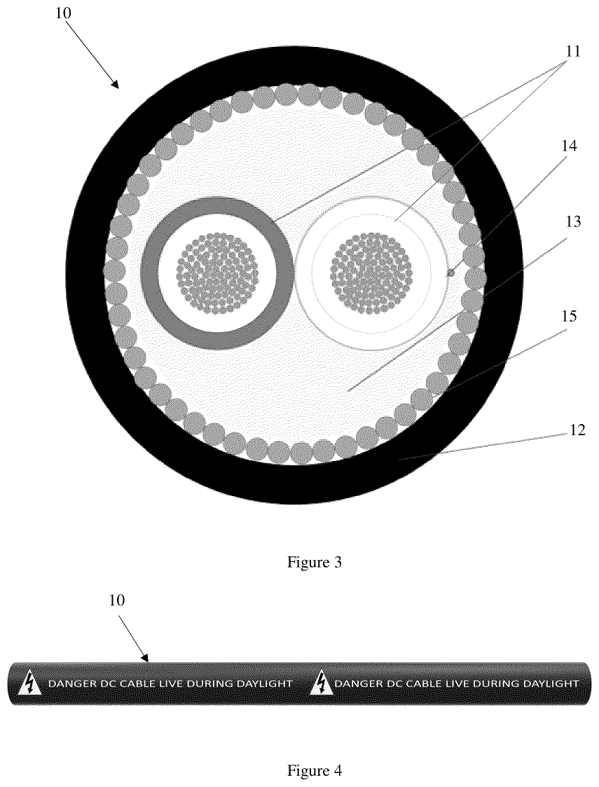

FIG. 3 is a schematic section view of a 2-core composite cable of an embodiment with an amour layer.

FIG. 4 is a side elevation view of a composite cable of an embodiment with warning message applied directly to the outer sheath.

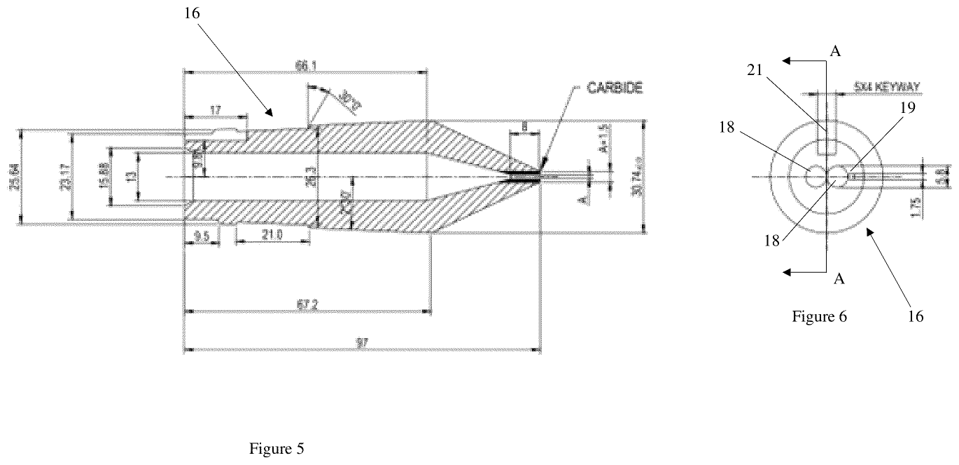

FIG. 5 is a sectional side view along line A-A of an extrusion tip for the central cores and ripcord for a 2-core 4.0 mm² tool embodiment of the present invention.

FIG. 6 is a front view of the extrusion tip illustrated in FIG. 5.

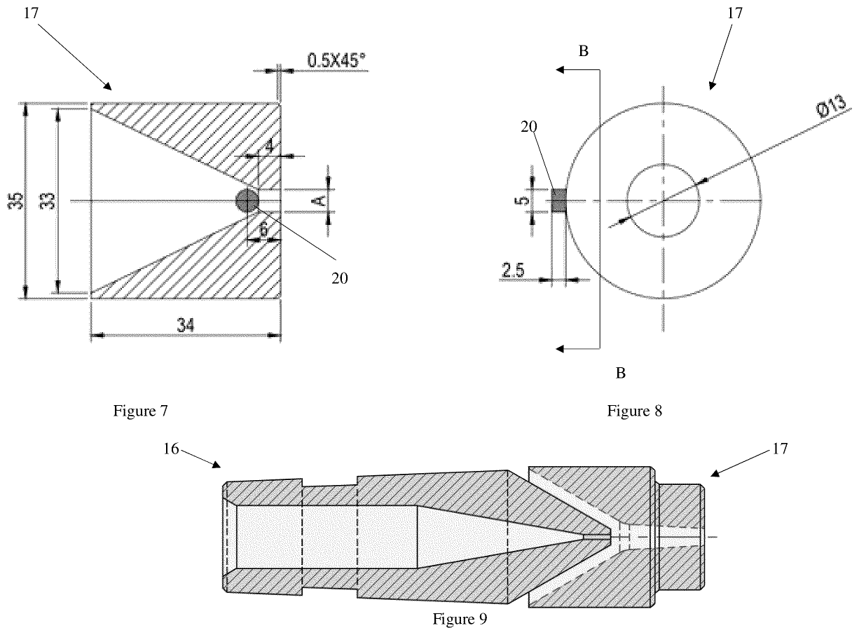

FIG. 7 is a sectional side view along line B-B of an extrusion die for a 2-core 4.0 mm² tool embodiment of the present invention showing the alignment key.

FIG. 8 is a front view of the extrusion die illustrated in FIG. 7.

FIG. 9 is a schematic sectional view showing the relative positioning of an extrusion tip and an extrusion die in normal use.

A composite photovoltaic cable 10 comprising two double insulated operating cores 11 within an outer jacket or sheath 12 is illustrated in FIG. 1. A composite photovoltaic cable 10 comprising four double insulated operating cores 11 within an outer jacket or sheath 12 is illustrated in FIG. 2.

Each of the operating cores 11 are ozone resistant, UV resistant, water resistant, low smoke, zero halogen and have a voltage rating of 1000/1500V suitable for photovoltaic (PV) applications. The operating cores 11 illustrated in FIGS. 1 to 3 are HIZ2Z2-K 6.0 mm², 6.1 mm outer diameter cores which are double insulated.

As shown in FIGS. 1 to 3, the double insulated operating cores 11 are provided approximately centrally within the outer jacket or sheath 12. The operating cores 11 shown abut each other. In FIG. 2, abutment of the cores 11 defines a void between them which is not filled in that embodiment.

The composite cable also includes bedding 13 within the outer jacket or sheath 12. The bedding 13 assists with defining the outer shape of the composite cable 10. The outer jacket or sheath 12 in FIGS. 1 and 2 is provided directly about the outer side of the bedding 13.

In FIG. 3, an armour layer 15 is provided about the outer side of the bedding 13 and within the outer jacket or sheath 12.

The bedding within the composite cable illustrated is polyvinylchloride with a K-value of between 35 and 80, di (2-propylheptyl) phthalate, at least one filler and a stabiliser.

As shown, the bedding 13 is provided within the composite cable 10 outside the operating cores 11 and within the outer jacket or sheath 12 of the composite cable 10. The bedding 13 is applied around the cores 11 and acts as a filler between the outer jacket or sheath 12 and the operating cores 11.

As shown, there is at least a predetermined minimum thickness of bedding provided about all sides of the individual cores 11 to ensure protection of the individual cores 11.

The composite cable illustrated also includes an elongate ripcord member 14 embedded within the composite cable 10 and configured to open the outer jacket 12 and any bedding 13.

The ripcord member 14 extends over the length of the composite cable 10, immediately adjacent to one of the individual operating cores 11 within the composite cable 10. In use, operating the ripcord member 14 which is located immediately adjacent to one of the individual operating cores 11 means that at least one of the individual operating cores 11 can be exposed without damaging the operating cores 11, allowing separation when needed as the bedding can also be peeled away from the cores 11.

In one form, the ripcord member 14 may be an engineered fibre ripcord and may be flat, twisted or corded.

A high tensile strength ripcord 14 is preferred given the size and nature of the larger composite cable 10 formed with the at least two individual operating cores 11.

As shown, the ripcord 14 is located within the composite cable 10 positioned next to the thinnest part of the bedding 13 to the outer jacket 12.

The ripcord 14 is coextensive with at least one of the operating cores 11.

An armoured version of the composite cable 10 as shown in FIG. 3 allows cable routes to be buried directly underground. The preferred position of the ripcord 14 in the armoured version shown in FIG. 3 shows a metal wire armour layer 15 applied between the bedding 13 and outer jacket 12, outside the ripcord 14. Once the outer jacket 12 has been cut and the armour layer 15 has been separated, the ripcord 14 can then be used as above to separate the bedding 13 adjacent to the individual core 11.

As shown in FIG. 4, a warning message can be printed directly on the outside of the outer jacket 14 of the cable 10 for additional safety and to maintain a message such as ‘DANGER DC CABLE LIVE DURING DAYLIGHT’. As the printing is on the cable 10, this removes the need for electricians to label the cable 10 continuously along its route.

The composite cable 10 of embodiments overcome these issues and will allow electrical installers to run a single cable that incorporates these double insulated operating cores 11, within an outer sheathing 12, whilst having warning labels already applied, reducing the possibility of mistaking the cable for ‘non-power’, and still allowing a long length of the double insulated operating cores 11 to be freed from each other at a solar array.

To achieve the preferred positioning of the ripcord 14 within the composite cable 10 as described above, a tool for manufacturing a composite cable is shown in FIGS. 5 to 8. The tool comprises an extrusion tip 16, an example is illustrated in FIGS. 5 and 6 and an extrusion die 17, an example is illustrated in FIGS. 7 and 8 located in series, as illustrated schematically in FIG. 9. This example is for a dual core, 4.0 mm² tool to form a 13 mm OD composite cable (before the outer sheath is applied).

As shown best in FIG. 6, the extrusion tip 16 comprises an opening 18 for each of the two double insulated operating cores and a secondary opening 19 provided adjacent to one of the openings 18 to position a ripcord 14 coextensively beside the one of the operating cores. In the illustrated configuration, the dimension of the secondary opening 19 is 1.75 mm which is larger than the dimension of the ripcord itself to allow the ripcord to be fed without snagging or friction into the secondary opening 19. When the bedding is applied about the assembled cores (5.8 mm each in OD), the bedded assembly with the surrounding bedding has a 13 mm OD, resulting in approximately 0.7 mm of bedding outside the ripcord at the thinnest point.

In use, the extrusion die 17 is located downstream of the extrusion tip 16 as shown schematically in FIG. 9. In the illustrated embodiment, the extrusion die 16 comprises a keying structure 20. The keying structure 20 is preferably located on an internal side of the extrusion die 17 as shown in FIG. 7 but may extend into the die 17 from outside as shown in FIG. 8.

The keying structure 20 may have any shape and any configuration but as the purpose of the keying structure 20 is to engage with a keyway 21 provided on the extrusion tip 16 to maintain the alignment of the two components, it is important that the shape and configuration of the keying structure 20 correspond to that of the corresponding keyway 21.

As shown, the extrusion tip 16 includes a keyway 21 in an external portion thereof to align the extrusion tip 16 with the extrusion die 17.

The keying structure 20 is received at least partially into the corresponding keyway 21 on the extrusion tip 16 to maintain the orientation of the extrusion tip 16 relative to the extrusion die 27. This alignment of the extrusion tip 16 relative to the extrusion die 17 will act to maintain the orientation of the individual cores 11 and the ripcord 14 as they exit the extrusion tip 16, relative to the extrusion die 17 to ensure that the ripcord 14 is positioned relative to the thinnest part of the bedding 13 extruded about the individual cores 11 and the ripcord 14 by the extrusion die 17.

In use, the at least two double insulated operating cores are fed into the extrusion tip 16 through the opening 18 for each and the ripcord 14 is fed at the same time into the secondary opening 19 provided adjacent to one of the openings 18, to form an internal core and ripcord configuration.

The internal core and ripcord configuration exiting the extrusion tip 16 is then fed through the extrusion die 17 with the bedding composition to form a bedded configuration which can then be sheathed with the outer jacket 12 to form the composite cable 10.

The keying structure 20 and keyway 21 discussed above will ensure that the internal core and ripcord configuration exiting the extrusion tip 16 is maintained aligned with the extrusion die 17 so that the ripcord 14 is positioned relative to the thinnest part of the bedding 13 extruded about the individual cores 11 and the ripcord 14 by the extrusion die 17.

The double insulated operating cores 11 are preferably fed directly into the extrusion tip 16 with the ripcord 14 being held on the outer edge of one of the double insulated operating cores 11 as shown, by the extrusion tip 16 to allow the ripcord 14 to be positioned next to the thinnest part of the bedding 13.

The running parameters of the manufacturing machine differ for each composite cable to account for different composite cable characteristics.

The one or more embodiments are described above by way of example only. Many variations are possible without departing from the scope of protection afforded by the appended claims.

1. A composite photovoltaic cable comprising at least two double insulated operating cores within an outer jacket or sheath.

2. A composite photovoltaic cable as claimed in claim 1 comprising two double insulated operating cores or four double insulated operating cores.

3. A composite photovoltaic cable as claimed in claim 1 wherein the at least two double insulated operating cores abut each other.

4. A composite photovoltaic cable as claimed in claim 1 wherein the composite cable further comprises bedding outside the at least two double insulated operating cores within the outer jacket or sheath.

5. A composite photovoltaic cable as claimed in claim 4 wherein the bedding within the composite cable is or includes a composition comprising polyvinylchloride with a K-value of between 35 and 80, di (2-propylheptyl) phthalate, at least one filler and a stabiliser-.

6. (canceled)

7. A composite photovoltaic cable as claimed in claim 1 further comprising an elongate ripcord member or structure at least partially embedded within the composite cable and configured to open the outer jacket and any bedding.

8. A composite photovoltaic cable as claimed in claim 7 wherein the ripcord member or structure is elongate, extending over the length of the composite cable.

9. A composite photovoltaic cable as claimed in claim 7 wherein the ripcord member or structure is located immediately adjacent to one of the operating cores within the composite cable.

10. (canceled)

11. A composite photovoltaic cable as claimed in claim 7 wherein the ripcord is located within the composite cable positioned with a smallest distance to the outer jacket or sheath.

12. A composite photovoltaic cable as claimed in claim 7 wherein the ripcord is coextensive with at least one of the operating cores.

13. (canceled)

14. A composite photovoltaic cable as claimed in claim 1 further comprising one or more armouring layers are applied within the outer jacket or sheath.

15. A composite photovoltaic cable as claimed in claim 1 further comprising a warning message printed directly on an outside of the outer jacket or sheath of the composite cable identifying that the composite cable is a photovoltaic cable.

16. A tool for manufacturing a composite cable comprising at least two double insulated operating cores, the tool comprising an extrusion tip and an extrusion die located in series, the extrusion tip comprising an opening for each of the at least two double insulated operating cores and a secondary opening provided adjacent to one of the operating cores to position a ripcord member or structure coextensively beside the one of the operating cores.

17. A tool as claimed in claim 16, wherein the extrusion die is located downstream of the extrusion tip, the extrusion die comprising a keying structure located on an internal side of the extrusion die.

18. A tool as claimed in claim 17, wherein the extrusion tip comprises at least one keyway in an external portion thereof to align the extrusion tip with the extrusion die.

19. A tool as claimed in claim 18, wherein the at least one keyway is provided relative to a front end of the extrusion tip.

20. A method of forming a composite cable comprising at least two double insulated operating cores, the method comprising the steps of feeding the at least two double insulated operating cores into an extrusion tip comprising an opening for each of the at least two double insulated operating cores and a secondary opening provided adjacent to one of the openings for a ripcord member or structure, and feeding the ripcord member or structure coextensively with the at least two double insulated operating cores through the extrusion tip to form an internal core and ripcord configuration.

21. A method as claimed in claim 20 further comprising a step of feeding the internal core and ripcord configuration through an extrusion die with at least one bedding composition to form a bedded configuration.

22. A method as claimed in claim 21 further comprising a step of sheathing the bedded configuration with at least one outer jacket or sheath to form a composite cable.

23. A method as claimed in claim 20 further comprising a step of feeding the least two double insulated operating cores directly into the extrusion tip with the ripcord held on an outer edge of one of the double insulated operating cores.

24. (canceled)
